(19) United States
(12) Patent Application Publication
(10) Pub. No.: US 2022/0274041 A1
(43) Pub. Date: Sep. 1, 2022

(54) SIDE ENTRY WAVE SEAL AIR CLEANER

(71) Applicant: Parker-Hannifin Corporation, Cleveland, OH (US)

(72) Inventors: James R. Manley, Myrtle, MS (US); Brian T. Ehrenberg, Kansas City, MO (US)

(73) Assignee: Parker-Hannifin Corporation, Cleveland, OH (US)

(21) Appl. No.: 17/592,118

(22) Filed: Feb. 3, 2022

Related U.S. Application Data
(60) Provisional application No. 63/153,971, filed on Feb. 26, 2021.
(60) Provisional application No. 63/167,696, filed on Mar. 30, 2021.

(51) Int. Cl. B01D 46/10; B01D 46/00; B01D 46/24; B01D 46/52; F02M 35/024

(52) U.S. Cl. CPC B01D 46/10; B01D 46/0004; B01D 46/0009; B01D 46/0015; B01D 46/2414; B01D 46/521; F02M 35/02425; F02M 35/02433; F02M 35/0245; F02M 35/02491; B01D 2265/025; B01D 2265/026; B01D 2265/028; B01D 2271/022

(57) ABSTRACT

A filter element having a filter media pack with an inlet end, outlet end, and outer periphery extending therebetween. The inlet and outlet ends are separated along an axis. The outer periphery includes a first pair of opposed sides between the inlet and outlet ends, and a second pair of opposed sides extending transversely between the first pair of opposed sides. A frame supports the outer periphery, having opposing first frame side segments, and a second frame segment. Each first frame side segment includes a pair of guide projections extending along respective first sides. The guide projections are spaced apart from one another from a broad end at one second side, to a narrow end at the other second side, and arranged to receive axial forces received within a housing having complementary engagement surfaces. A housing seal is supported along one guide projection, sealing against the complementary engagement surfaces.

### CROSS-REFERENCE TO RELATED PATENT APPLICATIONS

This patent application claims the benefit of U.S. Provisional Patent Application No. 63/167,696, Mar. 30, 2021, and claims the benefit of U.S. Provisional Patent Application No. 63/153,971 filed Feb. 26, 2021, the entire teachings and disclosures of which are incorporated herein by reference thereto.

### FIELD OF THE INVENTION

The present invention generally relates to air filter elements and/or air cleaners incorporating the same, and more particularly relates to one or more features associated with air filters to include side entry installation structures to facilitate installation and seal compression and/or seal shape configurations.

### BACKGROUND OF THE INVENTION

Filter assemblies may be used to filter any type of fluid, such as, for example, air, gasoline, diesel fuel, lubricating oil, water, coolant fluid, and others. Filters are commonly employed to remove particulate matter flowing in a fluid stream such as the removal of dust and other particulate from air in the case of an air filter. Air filtration products in particular are used in a variety of such applications, such as for example in the turbo engine components of a vehicle engine.

With respect to air filters and air filter elements, a variety of “side entry” air filters currently form the state of the art. For example, EP 1520975 to Maurer et al. entitled “Air Filter Apparatus in the Intake System of an Internal Combustion Engine” and assigned to Man and Hummel GmbH demonstrates a conventional side entry concept, whereby a filter element is installed into a side opening of a housing base that is covered by a pivoting housing lid to secure and seal the filter element in the housing between an inlet and an outlet. During pivoting movement of the lid, the lid cams and clamps the filter element into sealing relationship with the housing. There are other examples of such side entry filters including various embodiments disclosed in DE 102015009535 to Menben et al.; DE 102017001268 to Wubbeling; U.S. Pub. No. 2017/0095761 to Knight et al. entitled “Filter Assembly with Cam-Lock Filter Interface”; U.S. Pub. No. 2017/0304760 to Kaufmann et al. entitled “Housing Main Part of a Filter Housing, Filter System, and Pre-Separator Module of a Filter System”; WO 2017/133797 to Klaus-Dieter et al., entitled “Filter Element, Element Frame of a Filter Element, Filter Bellows of a Filter Element and Filter”; U.S. Pat. No. 7,396,375 to Nepsund et al. entitled “Housing and Method of Installation”; U.S. Pat. No. 7,323,029 to Engelland et al. entitled “Housing and Method of Installation”; U.S. Pat. No. 7,655,074 to Nepsund et al. entitled “Housing and Method of Installation”; U.S. Pat. No. 7,682,416 Engelland et al. entitled “Projections and Structure for Engaging Housing”; U.S. Pat. No. 7,905,936 to Coulonvau et al. entitled “Filter Arrangements, Housing Assemblies”; and U.S. Pat. No. 8,048,188 to Widerski et al. entitled “Projections and Structure for Engaging Housings”. Some of these designs such as that demonstrated by the EP 1520975 may suffer from space constraint drawbacks in that they require excessive space relative to filtration capacity, or do not afford certain space or shape envelope considerations or flexibility for engine applications where space may be limited or constrained. In other instances, there may be difficulties in either easily or reliably installing the filter, and/or reliability issues or complexities associated with proper installation or sealing of the filter.

Additionally, in the filter art, it is also known that wave seal configurations are provided. For example, the present assignee Parker-Hannifin (or its affiliate) has developed various wave seal configuration concepts for such filters disclosed in the art that include WO 2017/079191 entitled “Wave Seal for Filter Element” and U.S. Pat. No. 8,916,044 entitled “Filter Element Wave Gland Seal”; additionally, other seal configurations are shown, for example, in U.S. Pub. No. 2016/0236128 to Campbell et al. U.S. Pat. No. 10,729,999 entitled, “Wave Seal For Filter Element,” and U.S. Patent Pub. No. 2020/0072169 entitled, “Non-Cylindrical Filter Element and Side Entry Air Cleaner” disclose air filter elements. The entire teachings and disclosures of these patents and publications are hereby incorporated by reference as such wave seal configurations might optionally or alternatively be used in combination with other features herein.

With respect to conventional air filters, there is the potential for improvement, for example, in improving sealing effectiveness while increasing filtration capacity. Furthermore, it is desirable to maintain ease of installation and replacement of the filter element. There also have been issues of high cost in connection with manufacturing various filtration products, and air filtration products in particular. Particularly for irregular seal configurations, it is advantageous that the art provides embodiments of such side entry configurations that can be manufactured and installed in a reliable and noncomplex manner. Additionally, improvements for filter assembly implementations with respect to certain uncommon shapes of filter elements or configurations as to construction and installation are desirable.

Embodiments of the present invention provide improvements over the state of the art relative to side entry filters, installation or removal structures on filter elements that may be implemented, and/or new seal configurations for filters. These and other advantages of the invention, as well as additional inventive features, will be apparent from the description of the invention provided herein.

### BRIEF SUMMARY OF THE INVENTION

In one aspect, embodiments of the invention provide a filter element for an air filter. The filter element includes a filter media pack having an inlet end, an outlet end and an outer periphery extending between the inlet end and the outlet end. The inlet end and the outlet end are separated along a central axis. The outer periphery includes a first pair of opposed sides between the inlet end and the outlet end, and a second pair of opposed sides extending transversely between the first pair of opposed sides between the inlet end and the outlet end. A frame supports the outer periphery of the filter media pack. The frame includes opposing first frame side segments along the first pair of opposed sides of the media pack, and a second frame segment along at least one of the second opposed sides of the media pack. The first frame side segments each include a pair of guide projections extending along respective first sides of the media pack from one of the second sides to the other of the second sides. The guide projections are spaced apart from one another from a broad end at the one second side, to a narrow end at the other second side and arranged to receive axial forces when received within a housing having complementary engagement surfaces. A housing seal is supported by the support frame along at least one guide projection on each side of the media pack. Each housing seal is arranged to seal against one of the complementary engagement surfaces.

In the context of the present application, the term “axial” or “axially” is used to indicate force or movement in the direction of the central axis for the filter assembly and filter element.

In a particular embodiment, the guide projections define non-linear bearing surfaces. In a more particular embodiment, the guide projections extend in an undulating fashion from the one of the second sides to the other of the second sides. In some embodiments, the guide projections are symmetrical about a median line bisecting the respective frame side segment.

In a further embodiment, the filter element includes a handle along the second frame segment. In certain embodiments, the guide projections form a wedge shape. A filter assembly may include a filter housing with the aforementioned filter element in which the filter housing includes an open end configured to receive the filter element, and a cover hingedly attached to the housing and moveable so as to close the open end of the housing.

In another aspect, embodiments of the invention provide a filter element for an air filter. The filter element includes a filter media pack having an inlet end, an outlet end and an outer periphery extending between the inlet end and the outlet end. The inlet end and the outlet end are separated along a central axis. The outer periphery includes a first pair of opposed sides between the inlet end and the outlet end, and a second pair of opposed sides extending transversely between the first pair of opposed sides between the inlet end and the outlet end. A frame supports the outer periphery of the filter media pack. The frame includes opposing first frame side segments along the first pair of opposed sides of the media pack, and a second frame segment along at least one of the second opposed sides of the media pack. The first frame side segments each include a pair of guide projections along respective first sides of the media pack from one of the second sides to the other of the second sides. The guide projections are spaced apart from one another from a greater distance at the one second side, to a smaller distance at the other second side and arranged to receive axial forces when received within a housing having complementary engagement surfaces. A housing seal is supported by the frame along at least one guide projection on each side of the media pack. Each housing seal is arranged to seal against one of the complementary engagement surfaces.

In certain embodiments of the invention, the at least one guide projection defines a non-linear bearing surface. The at least one guide projection may extend in an undulating fashion from the one of the second sides to the other of the second sides. In some embodiments, one guide projection includes a plurality of spaced-apart, lateral projection components, with one of the projection components being closer to the one of the second sides, and another of the projection components being closer to the other of the second sides. In other embodiments, the projection components each include a curved contact surface. In certain embodiments of the invention, the projection components each comprise cylindrical posts.

The filter element may further include a handle along the second frame segment. In some embodiments, the guide projections form a wedge shape. A filter assembly may include a filter housing and the filter element in which the filter housing includes an open end configured to receive the filter element, and a cover hingedly attached to the housing and moveable so as to close the open end of the housing.

In yet another aspect, embodiments of the invention provide a filter element for an air filter. The filter element includes a filter media pack having an inlet end, an outlet end and an outer periphery extending between the inlet end and the outlet end. The inlet end and the outlet end are separated along a central axis. The outer periphery includes a first pair of opposed sides between the inlet end and the outlet end, and a second pair of opposed sides extending transversely between the first pair of opposed sides between the inlet end and the outlet end. A frame supports the outer periphery of the filter media pack. The frame includes opposing first frame side segments along the first pair of opposed sides of the media pack, and a second frame segment along at least one of the second opposed sides of the media pack. The first frame side segments each include a pair of guide projections along respective first sides of the media pack. The guide projections include: i) a non-linear guide projection component; and ii) a lateral projection component proximate one of the second opposed sides. The non-linear guide projection component and lateral projection component are arranged to receive axial forces when received within a housing having complementary engagement surfaces. A housing seal is supported by the frame along the non-linear guide projection component. The housing seal is arranged to seal against one of the complementary engagement surfaces.

In some embodiments, the guide projection components each include a curved contact surface. In other embodiments, the guide projection components each comprise cylindrical posts. In still other embodiments, the guide projection components are a combination of a curved contact surface and a cylindrical post.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a filter element for an air filter, constructed in accordance with an embodiment of the invention;

FIG. 2 is a plan view of a filter assembly incorporating a filter element, constructed in accordance with an embodiment of the invention;

FIG. 3 is a perspective view of a partial filter assembly of FIG. 2, according to an embodiment of the invention;

FIG. 4 is a perspective view of a fully assembled filter assembly, in accordance with an embodiment of the invention;

FIG. 5 is a perspective view of an alternate embodiment of a filter element for an air filter, constructed in accordance with an embodiment of the invention; and

FIG. 6 is a plan view of a filter assembly incorporating the filter element of FIG. 5, and constructed in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

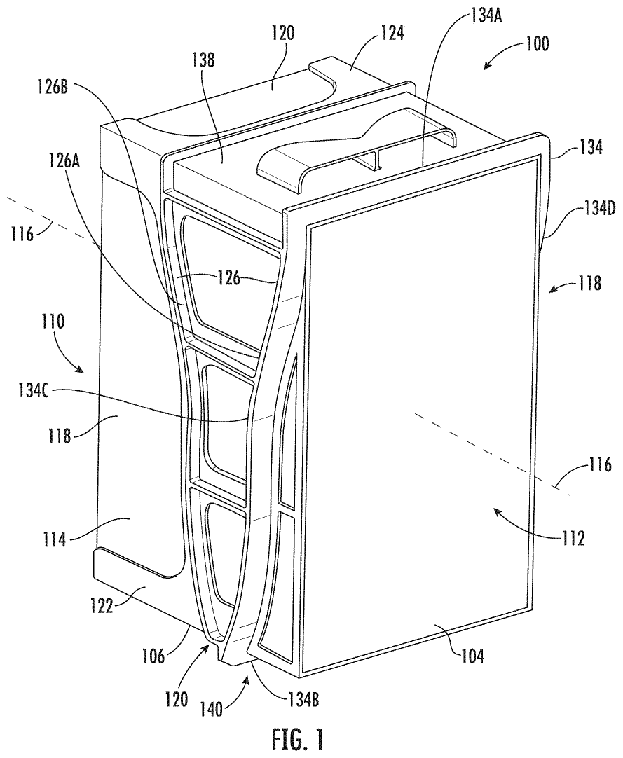

FIG. 1 shows a perspective view of a filter element 100 for an air filter such as might be used in a motor vehicle, and constructed in accordance with an embodiment of the invention. The filter element 100 includes a filter media pack 104, which may be a fluted media pack or a pleated media pack such as disclosed in U.S. Patent Publication No. 2020/0072169, for which the present application is an improvement over, and is thereby incorporated by reference. In some existing filter elements such as that disclosed in U.S. Patent Pub. No. 2020/0072169 referenced above, the filter element is inserted diagonally into a housing through one side of the housing. That diagonal insertion into the housing also typically includes a partial rotation or pivoting of the media pack into a position in which the housing seal seats and seals against a surface of the housing. In embodiments of the invention, the media pack 104 can be perpendicularly inserted into a housing 102 so that no partial rotation or pivoting of the media pack 104 is required.

The filter media pack 104 is installed within a support frame 106, and includes an inlet end 110, an outlet end 112, and an outer periphery 114 extending between the inlet end 110 and the outlet end 112. The inlet end 110 and the outlet end 112 are separated along a central axis 116. In the embodiments shown, the media pack 104 has a shape similar to a rectangular prism with three pairs of opposing sides. The outer periphery 114 includes a first pair 118 of opposed sides between the inlet end 110 and the outlet end 112, and a second pair 120 of opposed sides extending transversely between the first pair 118 of opposed sides between the inlet end 110 and the outlet end 112. The first pair 118 of opposed sides are preferably wider (in the direction perpendicular to the axis 116) than the second pair 120 of sides.

The support frame 106 supports the outer periphery 114 of the filter media pack 104. The support frame 106 includes opposing first frame side segments 122 along each of the first pair of opposed sides 118 of the media pack 104, and a second frame segment 124 along at least one of a second pair of opposed sides 120 of the media pack 104. First frame side segments 122 are preferably wider than second frame segments 124, to match the respective first pair 118 of opposed sides, and the second pair 120 of opposed sides.

The first frame side segments 122 each include a pair of guide projections 126 extending along a respective side of the pair of opposing first sides 118. In a particular embodiment, the guide projections 126 span an entire width of the opposed first sides 118 from one side 138 of the second pair of opposing sides 120 to the other side 140 of the second pair of opposing sides 120.

The guide projections 126 can be defined by opposed engagement surfaces, one surface for engaging a complimentary support abutment on the housing 102 and another surface for supporting a gasket (such as housing seal 134) for sealing purposes.

For example, the guide projections 126 can include a seal support flange 126A for support an axial seal gasket (e.g., housing seal 134) and an abutment flange 126B. Each of the seal support flange 126A and the abutment flange 126B can extend radially outward from sidewalls of the support frame 106. The seal support flange 126A typically extends in surrounding relation of the four sidewalls of the support frame 106.

In the embodiments shown, the guide projections 126 are variably spaced apart from one another with a broad spacing at the one side 138 of the second pair of opposing sides 120 where the distance between the guide projections 126 is at a maximum, to a narrow spacing at the other side 140 of the second pair of opposed sides 120 where the distance between the guide projections 126, is at a minimum. As shown in FIGS. 1-4, the distance between the opposed guide projections 126 is greatest at the one side 138 of the second pair of opposing sides 120, and gradually narrows during the progression from the one side 138 to the other side 140 of the second pair of opposing sides 120. Additionally, in certain embodiments, the distance between the opposed guide projections 126 may converge or come together at the other side 140 of the second pair of opposing sides 120.

As an example, a first edge 134A of the housing seal 134 is axially offset from the second edge 134B of the housing seal 134 on opposing sides (which may be along the shorter second pair 120 of sides), whereas third and fourth seal edges 134C and 134D (which may be along the longer first pair 118 of sides) extending along an oblique path (neither perpendicular nor parallel) relative to the central axis 116. The third and fourth seal edges 134C and 134D connect with the first and second seal edges 134A and 134B to axially offset.

The first and second seal edges 134A and 134B can extend perpendicularly to the central axis 116, and parallel to the inlet end 110.

Similar to the housing seal 134, the seal support flange 126A can have a first edge axially offset from the second edge on opposing sides (which may be along the shorter second pair 120 of sides) for the first and second edges 134A and 134B of the seal; and third and fourth connecting edges which may be along the longer first pair 118 of sides) extending along an oblique path (neither perpendicular nor parallel) relative to the central axis 116 for the third and fourth edges 134C and 134D of the housing seal 134.

Each of the seal support flange 126A and the abutment flange 126B can extend radially outward from sidewalls of the support frame. The seal support flange 126A typically extends in surrounding relation of the four sidewalls of the support frame 106, whereas the abutment flange 126B can be continuous so as to provide reliable axial sealing support force to the housing seal 134 or intermittent in surrounding relation.

In a particular embodiment of the invention, the guide projections 126 define undulating, non-linear bearing surfaces configured to support a wave-shaped housing seal 134. The housing seal 134 is supported by the support frame 106 along at least one guide projection 126 on each of the first pair of opposed sides 118 of the media pack 104, and along the one side 138 of the second pair of opposed sides 120. In particular embodiments, the guide projections 126 extend in an undulating, wave-shaped fashion from the one side 138 to the other side 140 of the second pair of opposing sides 120. Consequently, the wave-shaped housing seal 134 has the same undulating shape to allow the housing seal 134 to seat on the surface of the guide projection 126.

In the embodiment shown, the second frame segment 124 of the media pack 104 includes a handle 144, which may also serve as a cam locking projection to positively lock and engage with the housing cover. In certain embodiments, the guide projections 126 form a wedge shape. In some embodiments, the guide projections 126 are symmetrical about a median line 108 that extends perpendicularly to the central axis 116 and figuratively divides the opposing first frame side segments 122 into two pieces.

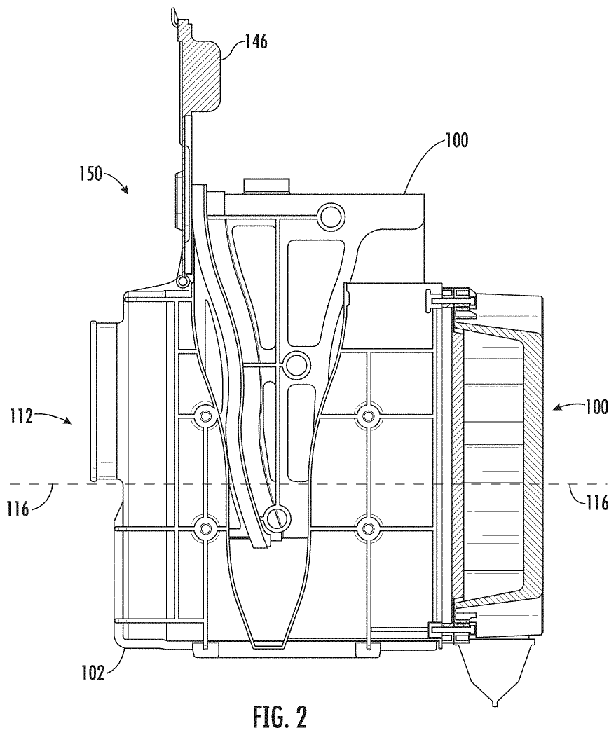

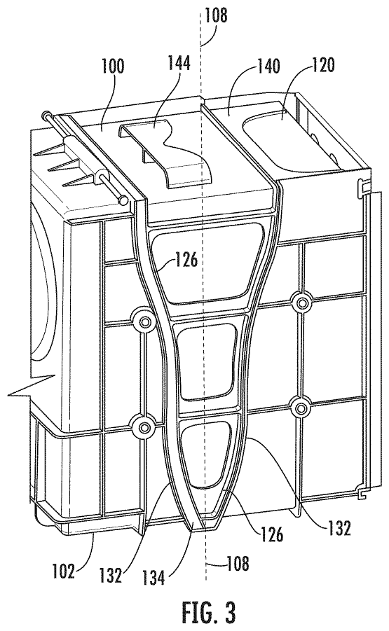

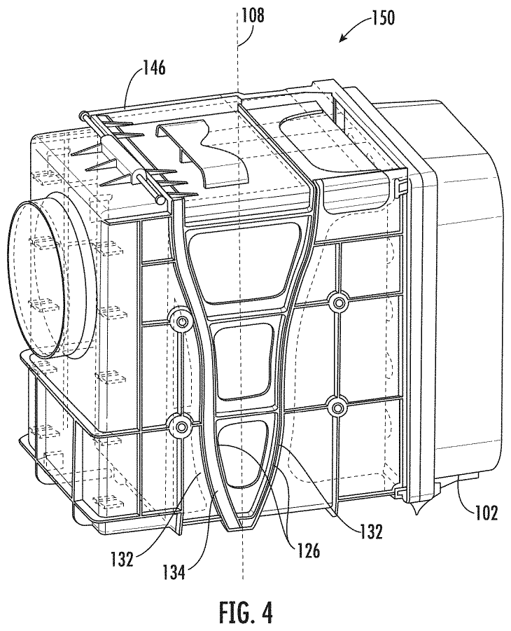

FIG. 2 is a plan view of the filter element 100 during insertion into the housing 102. As such, a housing cover or lid 146 is open. FIGS. 3 and 4 show perspective views of the filter assembly 150 with the filter element 100 fully inserted into the housing 102. As can be seen, the filter element 100 is installed into the housing 102 vertically, or at an angle normal to the central axis 116. Entry is typically through one side of the housing 102 in which an open end is configured to receive the filter element 100, and a lid or cover 146 hingedly attached to the housing 102 and moveable so as to close the open end of the housing 102 following installation of the filter element 100.

As a result, the housing 102 does not require the extra space upstream of the element face, as with some conventional filter assemblies. Thus, the filter assembly 150, as designed with the filter element 100 and the housing 102, is configured to maximize the use of volumetric space of the housing 102, while also removing the partial rotation or pivoting action used in some existing filter assemblies to seal the filter element 100 within the housing 102.

As explained above, the distance between the opposed guide projections 126 is greatest at the one side 138 of the second pair of opposing sides 120, and gradually narrows during the progression from the one side 138 to the other side 140 of the second pair of opposing sides 120. As a result of this arrangement, the guide projections 126 are configured to receive axial forces when received within the housing 102 having opposed complementary engagement surfaces 132. The housing seal 134 is arranged to seal against one of the complementary engagement surfaces 132. An axial seal pressure is created by the contact between the opposed complementary engagement surfaces 132 of the housing 102 and the opposed guide projections 126 of the filter element 100. In these embodiments, the seal pressure does not rely on the lid 146 forcing the filter element 100 into position. Accordingly, the stress on the lid 146, and the associated hinges and latches, is reduced as compared to some other filter assembly designs.

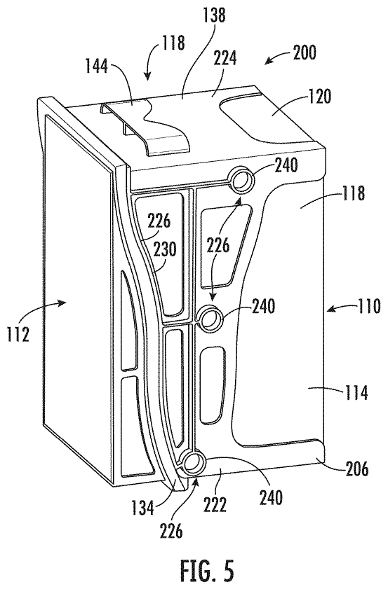

FIG. 5 is a perspective view of an alternate embodiment of a filter element 200 for an air filter, constructed in accordance with an embodiment of the invention. The filter element 200 is similar to the filter element 100 in many respects except for the configuration of the guide projections 226. That is, filter element 200 has the same filter media pack 104 with the inlet end 110, outlet end 112, and outer periphery 114.

In the embodiment shown, the support frame 206 supports the outer periphery 114 of the filter media pack 104. The support frame 206 includes opposing first frame side segments 222 along the first pair of opposed sides 118 of the media pack 104, and a second frame segment 224 along at least one of the second pair of opposed sides 120 of the media pack 104, the first frame side segments 222 each including a pair of guide projections 226 along each of the respective first pair of opposed sides 118 of the media pack 104. The guide projections 226 include a non-linear guide projection component 230, and a lateral projection component 240 proximate one of the second pair of opposed sides 120. The non-linear guide projection component 230 and lateral projection component 240 are arranged to receive axial forces when received within the housing 102 having complementary engagement surfaces 132.

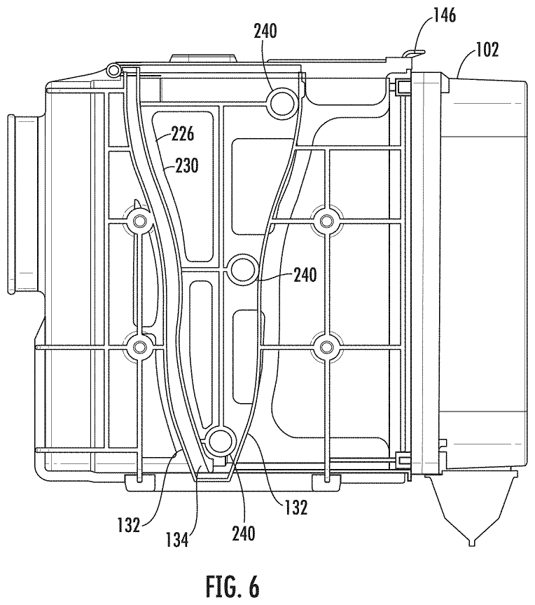

In some embodiments of the invention, the lateral projection component 240 includes one or more outwardly-projecting cylindrical posts. In other embodiments, the lateral projection component 240 includes circular bosses. In FIGS. 5 and 6, the lateral projection components 240 include plurality of spaced-apart, outwardly-projecting cylindrical posts 240, with one of the cylindrical posts 240 being closer to the one side 138 of the second pair of opposing sides 120, another of the cylindrical posts 240 being closer to the other side 140 of the second pair of opposing sides 120, and a third cylindrical post 240 being positioned mid-way between the one side 138 and the other side 140.

As shown, these posts 240 can collectively include one or more discontinuous abutment flanges similar to abutment flange 126B. In particular, the posts 240 each define a portion a guide projection surface for axial receipt of force to urge the seal support flange 126A into axial seal engagement.

FIG. 6 is a plan view of a filter assembly 250 incorporating the filter element 200 of FIG. 5, and constructed in accordance with an embodiment of the invention. As with filter element 100 described above, filter element 200 is installed into the housing 102 vertically, or at an angle normal to the central axis 116. Entry is typically through one side of the housing 102 in which an open end is configured to receive the filter element 100, and a lid or cover 146 hingedly attached to the housing 102 and moveable so as to close the open end of the housing 102 following installation of the filter element 200. As with the embodiment described above, in this embodiment, the seal pressure does not rely on the lid 146 forcing the filter element 200 into position. Accordingly, the stress on the lid 146, and the associated hinges and latches, is reduced as compared to some other filter assembly designs.

Thus, filter assembly 250 is also configured to maximize the use of volumetric space of the housing 102, while also removing the partial rotation or pivoting action used in some existing filter assemblies to seal the filter element 100 within the housing 102. This results in better use of space at a bottom of the housing 102.

The housing seal 134 of filter element 200 is supported by the support frame 206 along a surface of the non-linear guide projection component 230. The housing seal 134 is arranged to seat and seal against one of the complementary engagement surfaces 132 of the housing 102. Axial seal pressure is created by the three cylindrical posts 240 based on their contact with the complementary engagement surfaces 132 on the housing 102. It is understood that alternate embodiments of the filter element 200 may have more or less than three cylindrical posts 240, and further that the lateral projection components 240 may take a form other than that of a cylindrical post.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element for an air filter, the filter element comprising:
a filter media pack having an inlet end, an outlet end and an outer periphery extending between the inlet end and the outlet end, the inlet end and the outlet end being separated along a central axis, the outer periphery including a first pair of opposed sides between the inlet end and the outlet end, and a second pair of opposed sides extending transversely between the first pair of opposed sides between the inlet end and the outlet end; and
a frame supporting the outer periphery of the filter media pack, the frame including opposing first frame side segments along the first pair of opposed sides of the media pack, and a second frame segment along at least one of the second pair of opposed sides of the media pack, the first frame side segments each including a pair of guide projections extending along respective first sides of the media pack from one of the second sides to the other of the second sides, the guide projections being spaced apart from one another from a broad end at the one second side, to a narrow end at the other second side and arranged to receive axial forces; and
a housing seal supported by the frame along at least one guide projection on each side of the media pack.

2. The filter element as in claim 1, wherein the guide projections define non-linear bearing surfaces.

3. The filter element as in claim 2, wherein the guide projections extend in an undulating fashion from the one of the second sides to the other of the second sides.

4. The filter element as in claim 2, wherein the guide projections are symmetrical about a median line bisecting a respective frame side segment.

5. The filter element as in claim 1, and further including a handle along the second frame segment.

6. The filter element as in claim 1, wherein the guide projections form a wedge shape.

7. The filter element as in claim 1, wherein the guide projections include a seal support flange to support the housing seal, and an abutment flange for receiving the axial forces.

8. The filter element as in claim 7, wherein the seal support flange and the abutment flange extend radially outward from a sidewall of the support frame.

9. The filter element as in claim 1, wherein the housing seal has a first pair of opposed edges, wherein a first edge of the first pair is axially offset from a second edge of the first pair of opposed edges.

10. The filter element as in claim 1, wherein the housing seal has a second pair of opposed edges, wherein each of the second pair of opposed edges extends at an oblique angle relative to the central axis.

11. A filter assembly including a filter housing, and the filter element as in claim 1, wherein the filter housing includes an open end configured to receive the filter element, and a cover hingedly attached to the housing and moveable so as to close the open end of the housing.

12. A filter element for an air filter, the filter element comprising:
a filter media pack having an inlet end, an outlet end and an outer periphery extending between the inlet end and the outlet end, the inlet end and the outlet end being separated along a central axis, the outer periphery including a first pair of opposed sides between the inlet end and the outlet end, and a second pair of opposed sides extending transversely between the first pair of opposed sides between the inlet end and the outlet end; and
a frame supporting the outer periphery of the filter media pack, the frame including opposing first frame side segments along the first pair of opposed sides of the media pack, and a second frame segment along at least one of the second pair of opposed sides of the media pack, the first frame side segments each including a pair of guide projections extending along respective first sides of the media pack from one of the second sides to the other of the second sides, the guide projections being spaced apart from one another from a greater distance at the one second side, to a smaller distance at the other second side and arranged to receive axial forces; and
a housing seal supported by the frame along at least one guide projection on each side of the media pack.

13. The filter element as in claim 12, wherein the at least one guide projection defines a non-linear bearing surface.

14. The filter element as in claim 13, wherein the at least one guide projection extends in an undulating fashion from the one of the second sides to the other of the second sides.

15. The filter element as in claim 12, wherein one guide projection includes a plurality of spaced-apart, lateral projection components, with one of the projection components being closer to the one of the second sides, and another of the projection components being closer to the other of the second sides.

16. The filter element as in claim 15, wherein the projection components each includes a curved contact surface.

17. The filter element as in claim 16, wherein the projection components each comprise cylindrical posts.

18. The filter element as in claim 12, and further including a handle along the second frame segment.

19. The filter element as in claim 12, wherein the guide projections form a wedge shape.

20. The filter element as in claim 12, wherein the guide projections include a seal support flange to support the housing seal, and an abutment flange for receiving the axial forces.

21. The filter element as in claim 20, wherein the seal support flange and the abutment flange extend radially outward from a sidewall of the support frame.

22. The filter element as in claim 12, wherein the housing seal has a first pair of opposed edges, wherein a first edge of the first pair is axially offset from a second edge of the first pair of opposed edges.

23. The filter element as in claim 12, wherein the housing seal has a second pair of opposed edges, wherein each of the second pair of opposed edges extends at an oblique angle relative to the central axis.

24. A filter assembly including a filter housing, and the filter element as in claim 8, wherein the filter housing includes an open end configured to receive the filter element, and a cover hingedly attached to the housing and moveable so as to close the open end of the housing.

25. A filter element for an air filter, the filter element comprising:
a filter media pack having an inlet end, an outlet end and an outer periphery extending between the inlet end and the outlet end, the inlet end and the outlet end being separated along a central axis, the outer periphery including a first pair of opposed sides between the inlet end and the outlet end, and a second pair of opposed sides extending transversely between the first pair of opposed sides between the inlet end and the outlet end; and
a frame supporting the outer periphery of the filter media pack, the frame including opposing first frame side segments along the first pair of opposed sides of the media pack, and a second frame segment along at least one of the second pair of opposed sides of the media pack, the first frame side segments each including a pair of guide projections along respective first sides of the media pack, the guide projections including: i) a non-linear guide projection component; and ii) a lateral projection component proximate one of the second pair of opposed sides; the non-linear guide projection component and lateral projection component arranged to receive axial forces; and
a housing seal supported by the frame along the non-linear guide projection component.

26. The filter element as in claim 25, wherein the non-linear guide projection component includes a non-linear bearing surface and extends in an undulating fashion from one side of the second pair of opposed sides to the other side of the second pair of opposed sides.

27. The filter element as in claim 25, wherein the lateral projection component includes one or more cylindrical posts.

28. The filter element as in claim 25, wherein the lateral projection component includes three cylindrical posts.
